(19) United States
(12) Patent Application Publication
(10) Pub. No.: US 2004/0250656 A1
(43) Pub. Date: Dec. 16, 2004

(54) Semi-automatic jar opener

(76) Inventor: Donald Tremblay, Ste-Foy (CA)

Correspondence Address: Mr. Donald Tremblay, 835 , du Coteau, Ste-Foy, QC, G1X 2P1, CA

(21) Appl. No.: 10/445,422

(22) Filed: May 28, 2003

(51) Int. Cl. B67B 7/00

(52) U.S. Cl. 81/3.2

(57) ABSTRACT

The present invention is a semi-automatic device including an electric motor which is activated by a run button for making turn a lower plate on which is mounted two L-shaped bars containing teeth on a face for meshing with a small gear activating each jaw for squeezing a jar that is placed between each rubber strip mounted on the lower plate for it preventing to slide when it makes turn an upper plate under which is mounted two L-shaped bars containing teeth on a face for meshing with a small gear activating each jaw for squeezing a lid that is placed between each rubber strip mounted under the upper plate for it preventing to slide until the time that the lid become loose, and the electric motor stops automatically when the torque falls to zero.

### BACKGROUND OF THE INVENTION

1. Field of the Invention

The present invention relates to a semi-automatic device used for loosening a jar lid without physical strength.

2. Description of the related art:

A search of prior art records has unveiled the following patents:

1. U.S. Pat. No. 4,171,650 issued in 1979 to Cardinal;

2. U.S. Pat. No. 4,262,560 issued in 1981 to Hoffberger;

3. U.S. Pat. No. 4,768,402 issued in 1988 to Kele; and

4. U.S. Pat. No. 6,148,692 issued in 2000 to Russell.

The patents to Cardinal and Russell are probably the most relevant.

It is a principal object of this invention therefore to provide a semi-automatic device for loosening ajar lid, and which can be easily used by an handicapped person, elder or other person without physical strength.

### SUMMARY OF THE INVENTION

The present invention relates to a semi-automatic device including an electric motor which is activated by a run button for making turn a lower plate on which is mounted two L-shaped bars with jaw, which containing teeth on a face for meshing with a small gear activating each jaw provided with a rubber pad for squeezing ajar that is placed between each rubber strip mounted on the lower plate for it preventing to slide when it makes turn an upper plate under which is mounted two L-shaped bars with jaw, and which containing teeth on a face for meshing with a small gear activating each jaw for squeezing a lid that is placed between each rubber strip mounted under the upper plate for it preventing to slide until the time that the lid become loose, and the electric motor stops automatically when the torque falls to zero.

A horizontal shaft passes therethrough each hole of a support member that is fixed on the upper circular body for connecting each gear to each knob enabling to lower manually the upper circular body on the lid in pulling on a knob.

Further, a knob is formed with a locking member for blocking the upper circular body of the semi-automatic device when it is unused.

### ADVANTAGES OF THE INVENTION

No physical strength required from the user;

Can be operated only with one hand;

Easy to operate; and

Does not require to be fixed at any surface.

### BRIEF DESCRIPTION OF THE SEVERAL VIEWS OF THE DRAWINGS(S)

FIG. 1 is a front perspective view of a jar lid loosening semi-automatic device;

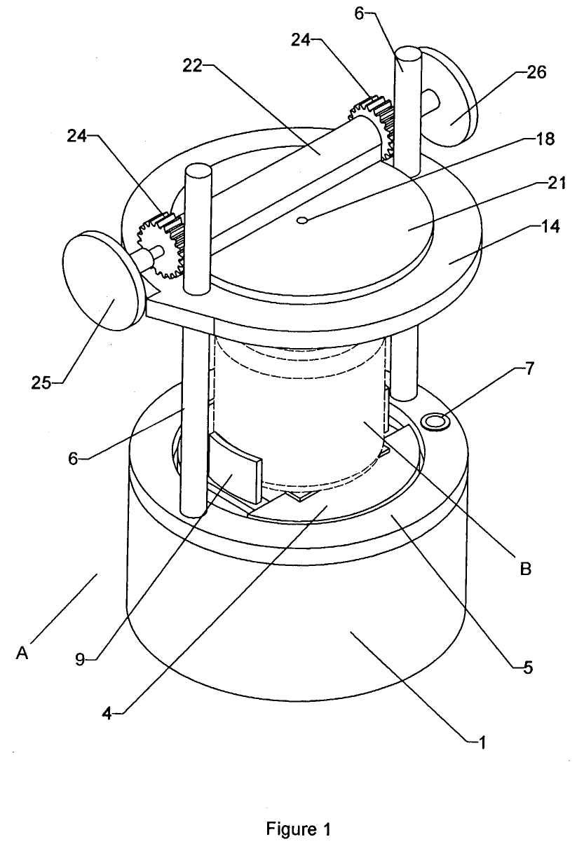

FIG. 2 is a front elevational view thereof;

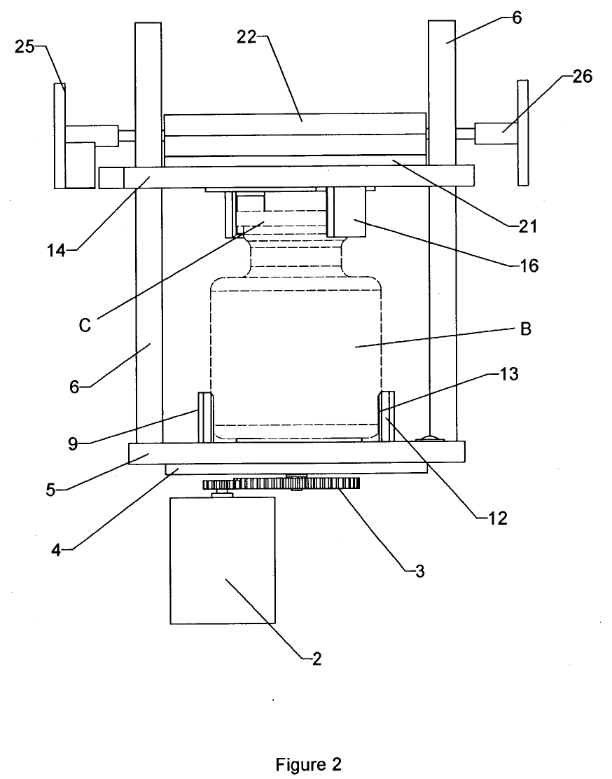

FIG. 3 is a perspective view of the lower part of the semi-automatic device;

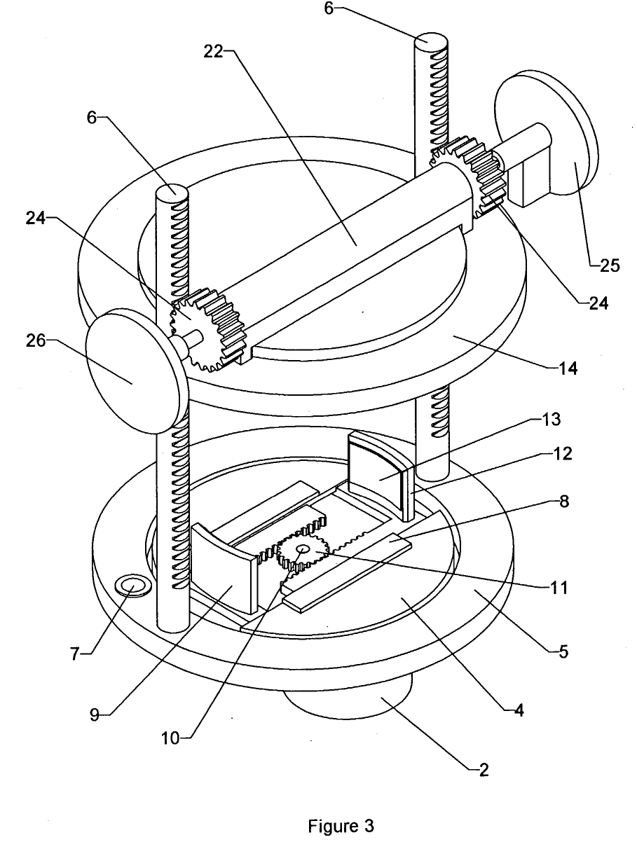

FIG. 4 is a perspective view of the upper part of the semi-automatic device;

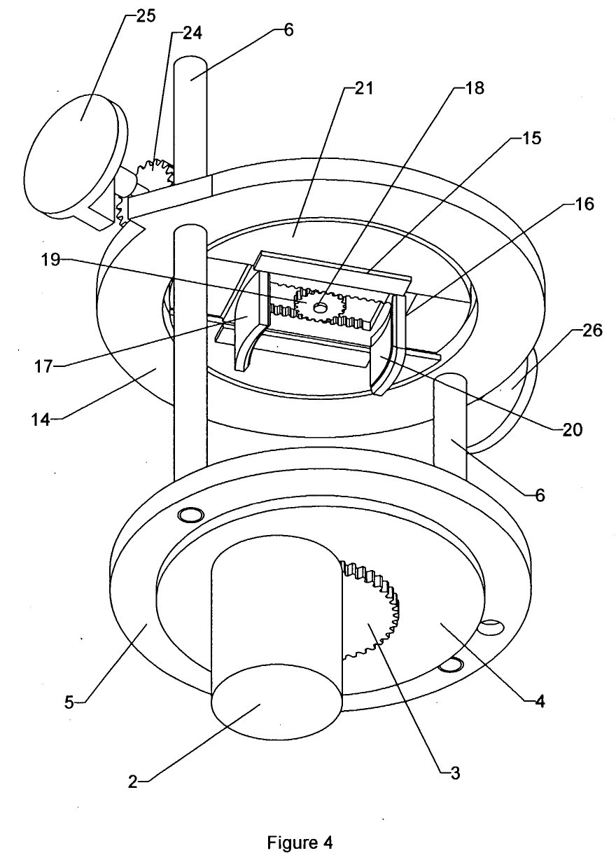

FIG. 5 is an exploded view of the FIG. 3; and

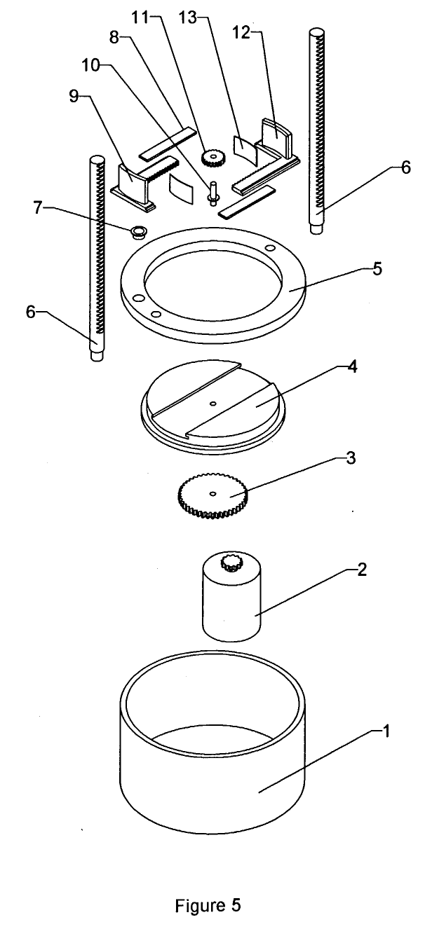

FIG. 6 is an exploded view of the FIG. 4.

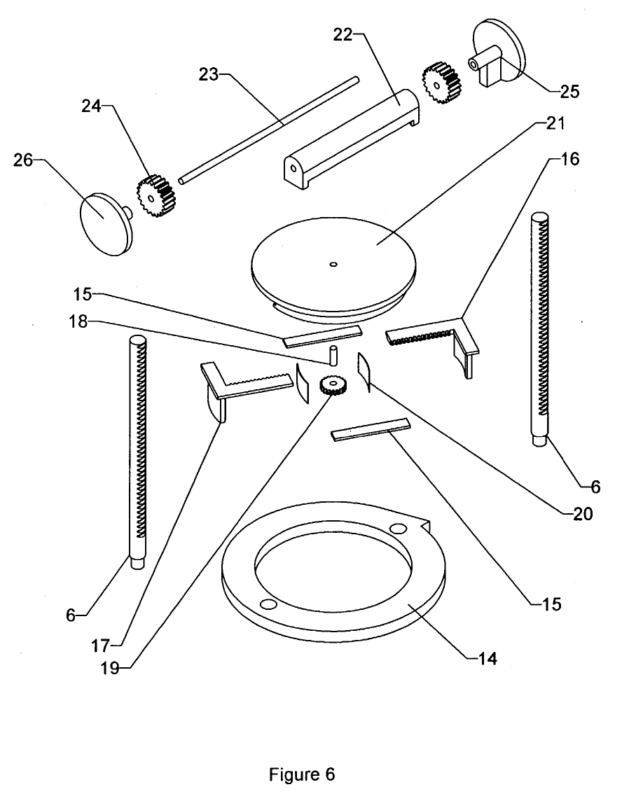

### DETAILED DESCRIPTION OF THE INVENTION

Referring to the drawings 1 to 6, a semi-automatic device (A) having a base (1) including an electric motor (2) which is activated by a run button (7) mounted on a lower circular body (5).

The electric motor (2) is formed with a small gear for meshing with a large gear (3) which is mounted under a lower plate (4) located inside the lower circular body (5) including holes and being connected on the base (1).

A vertical shaft (10) is connected to the large gear (3) and to a small gear (11) for meshing with each L-shaped bar containing teeth on a face, and activating each jaw (9)(12) provided with a rubber pad (13) for squeezing a jar (B) that is placed between each rubber strip (8) mounted on the lower plate (4) for it preventing to slide when it makes turn an upper plate (21) rested against a lid (C).

Each L-shaped bar containing teeth on a face and formed with jaw (16)(17) are mounted under the upper plate (21) for meshing with a small gear (19) which is engaged on a vertical shaft (18) connected to the upper plate (21) located inside an upper circular body (14), and which enables when it is rested against the lid (C) to turn and activate each jaw (16)(17) provided with a rubber pad (20) for squeezing and blocking the lid (C) that is placed between each rubber strip (15) mounted under the upper plate (21) for it preventing to slide until the time that the lid (C) become loose, and the electric motor (2) stops automatically when the torque falls to zero.

Further, the upper circular body (14) is formed with holes for receiving each jagged post (6) that is engaged therein each hole of the lower circular body (5).

An horizontal shaft (23) passes therethrough each hole of a support member (22) that is fixed on the upper circular body (14) for connecting each gear (24) to each knob (25)(26) enabling to lower manually the upper circular body (14) on the lid (C) in pulling on a knob (25).

The knob (25) is formed with a locking member for blocking the upper circular body (14) of the semi-automatic device (A) when it is unused.

Although only a single embodiment of the present invention has been described and illustrated, the present invention is not limited to the features of this embodiment, but includes all variations and modifications within the scope of claims.

I claim:

1. A semi-automatic device having a base including an electric motor which is activated by a run button mounted on a lower circular body, and which is formed with a small gear for meshing with a large gear mounted under a lower plate located inside the lower circular body including holes and being connected on said base.

2. A vertical shaft is connected to said large gear and to a small gear for activating each jaw provided with a rubber pad for squeezing a jar that is placed between each rubber strip mounted on said lower plate for it preventing to slide when it makes turn an upper plate rested against a lid.

3. Each L-shaped bar containing teeth on a face is mounted under said upper plate for meshing with a small gear that is engaged on a vertical shaft connected to said upper plate located inside an upper circular body, and which enables when it is rested against the lid to turn and activate each jaw provided with a rubber pad for squeezing and blocking said lid that is placed between each rubber strip mounted under said upper plate for it preventing to slide until the time that the lid become loose, and the electric motor stops automatically when the torque falls to zero.

4. The upper circular body of claim 3, further includes holes for receiving each jagged post that is engaged therein each hole of the lower circular body.

5. A horizontal shaft passes therethrough each hole of a support member that is fixed on said upper circular body for connecting each gear to each knob enabling to lower manually said upper circular body on the lid in pulling on a knob.

6. A knob of claim 5, further includes a locking member for blocking said upper circular body of the semi-automatic device when it is unused.
